(19) United States
(12) Patent Application Publication
(10) Pub. No.: US 2025/0208545 A1
(43) Pub. Date: Jun. 26, 2025

(54) IMAGE FORMING APPARATUS, IMAGE FORMING METHOD, AND RECORDING MEDIUM

(71) Applicant: Konica Minolta, Inc., Tokyo (JP)

(72) Inventors: Shinichi TSUKAMURA, Uenohara-shi (JP); Nobuyasu TAMURA, Tokyo (JP)

(21) Appl. No.: 18/976,556

(22) Filed: Dec. 11, 2024

(30) Foreign Application Priority Data
Dec. 21, 2023 (JP) 2023-215478

(51) Int. Cl. G03G 15/20; G03G 15/00

(52) U.S. Cl. CPC G03G 15/2039; G03G 15/2064; G03G 15/6517; G03G 15/6591

(57) ABSTRACT

Disclosed is an image forming apparatus, including: an image forming section forming an image on a multilayered recording medium; a hardware processor acquiring information on the recording medium; a first process member physically acting on the recording medium from a first side on which the image is to be formed; and a second process member physically acting on the recording medium from a second side opposite to the first side. The hardware processor adjusts a physical property of at least the first process member acting on the recording medium based on a first property of an uppermost layer on the first side of the recording medium, the first property being acquired by the hardware processor, and adjusts a physical property of at least the second process member acting on the recording medium, based on a second property of an uppermost layer on the second side of the recording medium.

### CROSS-REFERENCE TO RELATED APPLICATIONS

The entire disclosure of Japanese Patent Application No. 2023-215478, filed on Dec. 21, 2023, is incorporated herein by reference in its entirety.

### BACKGROUND OF THE INVENTION

### Technical Field

The present invention relates to an image forming apparatus, an image forming method, and a recording medium.

### Description of Related Art

Conventionally, an image forming apparatus using an electrophotographic process technology has been known. In the image forming apparatus, an electrostatic latent image is formed by irradiating a charged photoreceptor with laser light based on image data. The image forming apparatus supplies toner from a developing device to a photosensitive drum on which the electrostatic latent image has been formed, thereby visualizing the electrostatic latent image and forming a toner image. Next, the image forming apparatus transfers the formed toner image onto a recording medium P, and then applies heat and pressure to fix the image onto the recording medium.

Recording media have different characteristics, such as thermal conductivity, depending on their paper types. Therefore, even if the toner image is heated at a constant temperature, the heating temperature may be lowered depending on the type of the recording medium, failing to achieve a sufficient fixing temperature, which may result in a fixing failure. Therefore, for example, Japanese Unexamined Patent Publication No. 10-161438 describes an image forming apparatus that acquires information on the paper type of a recording medium and controls a heating temperature in accordance with the information.

### SUMMARY OF THE INVENTION

However, for example, in a case where a recording medium is a tack paper having a multilayer structure that includes a surface base material and a release paper, the heat transfer temperature to a heating surface varies depending on not only the paper type of the surface base material serving as the heating surface but also the paper type of the release paper facing the surface base material. For this reason, when the temperature (physical quantity) is controlled only by information that the recording medium is the tack paper or information on the type of the surface base material, an appropriate fixing temperature may not be achieved, resulting in a fixing failure. In addition, a physical quantity that affects image quality during image formation on such a recording medium that has a multilayer structure is not limited to temperature, but includes the amount of charge.

The present invention has been made in view of such circumstances. It is an object of the present invention to provide an image forming apparatus, an image forming method, and a recording medium each allowing for a more suitable process in providing a recording medium that has a multilayer structure on which an image is formed.

To achieve at least one of the abovementioned objects, an image forming apparatus reflecting one aspect of the present invention comprises: an image forming section that forms an image on a recording medium having a multilayer structure; a hardware processor that acquires information on the recording medium; a first process member that physically acts on the recording medium from a first side on which the image is to be formed; and a second process member that physically acts on the recording medium from a second side opposite to the first side, wherein the hardware processor adjusts a physical property of at least the first process member, the physical property acting on the recording medium, based on a first property of an uppermost layer on the first side of the recording medium, the first property being acquired by the hardware processor, and adjusts a physical property of at least the second process member, the physical property acting on the recording medium, based on a second property of an uppermost layer on the second side of the recording medium.

To achieve at least one of the abovementioned objects, an image forming method of an image forming apparatus, wherein the image forming apparatus includes: an image forming section that forms an image on a recording medium having a multilayer structure; a hardware processor that acquires information on the recording medium; a first process member that physically acts on the recording medium from a first side on which the image is to be formed; and a second process member that physically acts on the recording medium from a second side opposite to the first side, reflecting another aspect of the present invention comprises: adjusting a physical property of at least the first process member, the physical property acting on the recording medium, based on a first property of an uppermost layer on the first side of the recording medium, the first property being acquired by the hardware processor; and adjusting a physical property of at least the second process member, the physical property acting on the recording medium, based on a second property of an uppermost layer on the second side of the recording medium.

To achieve at least one of the abovementioned objects, a non-transitory recording medium storing a computer-readable program for an image forming apparatus, wherein the image forming apparatus includes: an image forming section that forms an image on a recording medium having a multilayer structure; a hardware processor that acquires information on the recording medium; a first process member that physically acts on the recording medium from a first side on which the image is to be formed; and a second process member that physically acts on the recording medium from a second side opposite to the first side, reflecting yet another aspect of the present invention causes the hardware processor to: adjust a physical property of at least the first process member, the physical property acting on the recording medium, based on a first property of an uppermost layer on the first side of the recording medium, the first property being acquired by the hardware processor; and adjust a physical property of at least the second process member, the physical property acting on the recording medium, based on a second property of an uppermost layer on the second side of the recording medium.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating the main configuration of an image forming apparatus according to a first embodiment;

FIG. 2 is a block diagram illustrating the image forming apparatus;

FIG. 3 is a schematic diagram illustrating a multilayer structure of a tack paper;

FIG. 4 is a diagram illustrating a detailed configuration of a fixing section;

FIG. 5 is a flowchart of an image forming process;

FIG. 6A is an example of a recording medium setting change screen;

FIG. 6B is an example of a recording medium type setting screen;

FIG. 6C is an example of a release paper type setting screen;

FIG. 7A is an example of a temperature setting table based on types of a surface base material and a release paper;

FIG. 7B is an example of a temperature setting table based on the types of the surface base material and the release paper;

FIG. 7C is an example of a temperature correction table based on the basis weight of the surface base material and the release paper;

FIG. 7D is an example of a temperature correction table based on the thicknesses of the surface base material and the release paper; and

FIG. 8 is a diagram illustrating the main configuration of an image forming apparatus according to a second embodiment.

### DETAILED DESCRIPTION

Hereinafter, one or more embodiments of the present invention will be described with reference to the drawings. However, the scope of the invention is not limited to the disclosed embodiments. In the following description, components having the same functions and configurations are denoted by the same reference numerals, and the description thereof will be omitted.

### Overall Configuration of Image Forming Apparatus

### First Embodiment

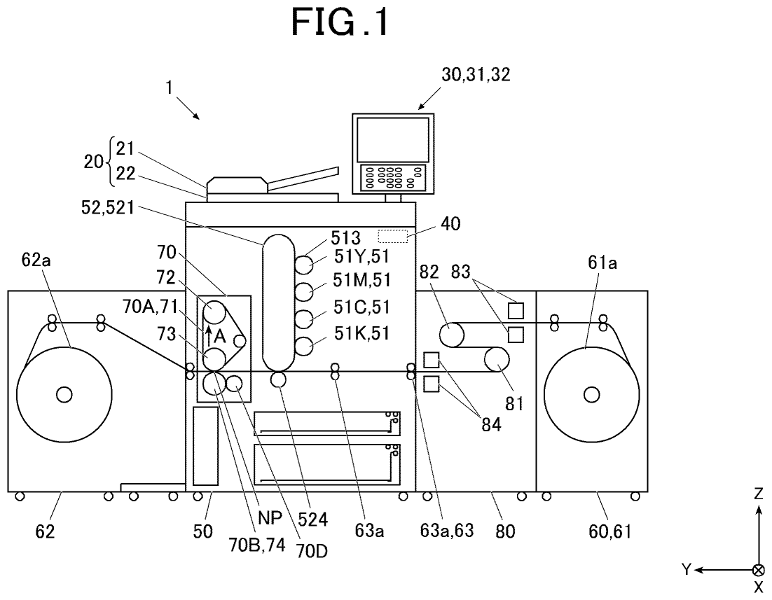

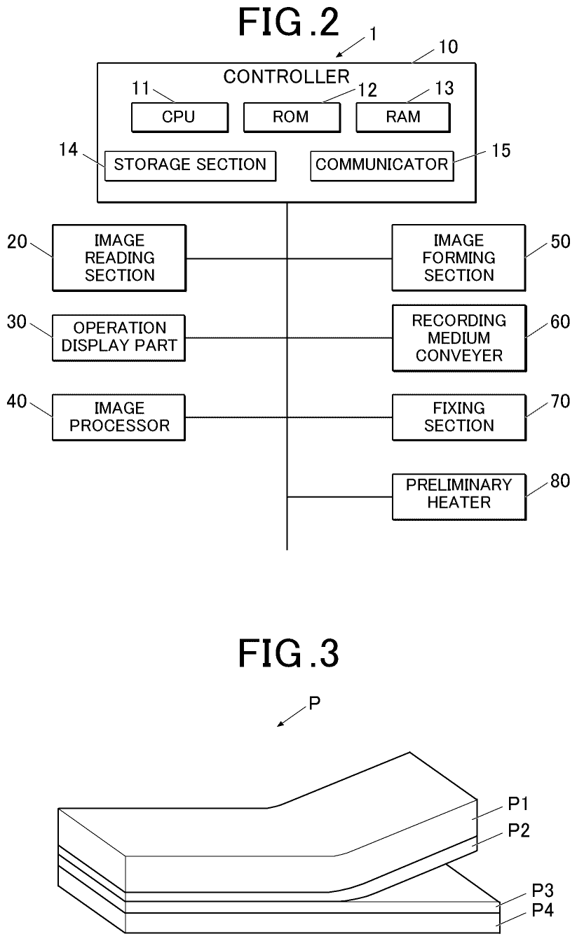

FIG. 1 is a side cross-sectional view of the main configuration of an image forming apparatus 1 according to a first embodiment of the present invention. FIG. 2 is a block diagram illustrating a functional configuration of the image forming apparatus 1. The image forming apparatus 1 includes a controller 10, an image reading section 20, an operation display part 30, an image processor 40, an image forming section 50, a recording medium conveyer 60, a fixing section 70, a preliminary heater 80, and the like.

Note that hereinafter, an X direction, a Y direction, and a Z direction refer to the directions illustrated in

FIG. 1. Furthermore, in the description below, the X direction, the Y direction, and the Z direction are referred to as a width direction, a conveyance direction, and a height direction, respectively.

The image forming apparatus 1 according to the present embodiment is a color image forming apparatus of an intermediate transfer method using an electrophotographic process technology. That is, the image forming apparatus 1 primarily transfers toner images of respective colors of Y (yellow), M (magenta), C (cyan), and K (black) formed on photosensitive drums 513, which will be described below, to an intermediate transfer belt 521 and superimposes the toner images on one another. Then, the image forming apparatus 1 secondarily transfers the toner images on the intermediate transfer belt 521 to a recording medium P to form an image.

As illustrated in FIG. 1, the recording medium P according to the embodiment of the present invention is a roll of continuous paper. In addition, the recording medium P according to the embodiment of the present invention is, for example, a recording medium P having a multilayer structure called a tack paper.

The structure of the recording medium P, which is a tack paper, is illustrated in FIG. 3. The tack paper has a multilayer structure in which a surface base material P1, an adhesive P2, a release agent P3, and a release paper P4 are laminated in this order from a first side which faces the image forming section 50 and on which an image is to be formed. The surface base material P1 is the uppermost layer on the first side. The release paper P4 is the uppermost layer on a second side opposite to the first side. The surface base material P1 is releasably attached to the release paper P4 by the adhesive P2 and the release agent P3. The surface base material P1 and the release paper P4 are made of, for example, paper or polyethylene terephthalate (PET).

### Controller

### CPU, ROM, RAM, Storage Section

The controller 10 includes a central processing unit (CPU; hardware processor) 11, a read only memory (ROM) 12, a random access memory (RAM) 13, a storage section 14, and the like.

The CPU 11 reads a program corresponding to processing content from the ROM 12, loads the program in the RAM 13, and centrally controls operations of components constituting the image forming apparatus 1 in cooperation with the loaded program. At this time, various kinds of data stored in the storage section 14 are referred to. The storage section 14 includes, for example, a nonvolatile semiconductor memory (so-called flash memory) or a hard disk drive.

### Communicator

The controller 10 transmits and receives various data to and from other devices such as an external personal computer connected to a communication network such as a local area network (LAN) or a wide area network (WAN) via a communicator 15.

The controller 10, for example, receives image data transmitted from an external device, and forms toner images on the recording medium P by the image forming section 50 based on the image data (input image data).

The communicator 15 includes a communication control card such as a LAN card.

### Image Reading Section

The image reading section 20 acquires the input image data without depending on the communicator 15. The image reading section 20 includes an automatic document sheet feed device 21 called an auto document feeder (ADF), a document image scanning device 22 (scanner), and the like.

### Automatic Document Sheet Feed Device

The automatic document sheet feed device 21 conveys a document placed on a document tray by a conveyance mechanism and sends the document to the document image scanning device 22. The automatic document sheet feed device 21 can continuously read images (including both sides) of a large number of documents placed on the document tray all at once.

### Document Image Scanning Device

The document image scanning device 22 optically scans a document conveyed from the automatic document sheet feed device 21 onto a contact glass or a document placed on the contact glass. Then, the document image scanning device 22 forms an image according to reflected light from the document on a light receiving surface of a charge coupled device (CCD) sensor (not illustrated) to read a document image.

The image reading section 20 generates input image data based on a reading result of the document image scanning device 22. The input image data undergoes predetermined image processing in the image processor 40.

### Operation Display Part

The operation display part 30 accepts various kinds of input operation by a user and outputs an operation signal to the controller 10. The operation display part 30 includes, for example, a liquid crystal display (LCD) with a touch screen, and functions as a display part 31 and an operation part 32.

### Display Part

The display part 31 displays various operation screens, a state of an image, an operation status of each function, and the like in accordance with display control signals input from the controller 10 or the user.

### Operation Part

The operation part 32 includes various operation keys such as a numeric keypad and a start key, and receives various operation instructions from the user.

In addition, the user inputs information on the recording medium P via the operation display part 30 in an image forming process to be described below. The information on the recording medium P input by the user includes paper types, thicknesses, basis weights, and the like of the surface base material P1 and the release paper P4 of the recording medium P having a multilayer structure.

### Image Processor

The image processor 40 includes a circuit and the like that performs digital image processing on the input image data in accordance with initial settings or user settings. For example, the image processor 40 performs tone correction based on tone correction data (tone correction table) under control of the controller 10. The image processor 40 performs, on the input image data, not only the tone correction but also various kinds of correction processing such as color correction and shading correction, compression processing, and the like. The image forming section 50 is controlled based on the processed image data.

### Image Forming Section

The image forming section 50 includes image forming units 51Y to 51K, an intermediate transfer unit 52, and the like for forming an image with each color toner of Y to K based on the input image data.

### Image Forming Unit

The image forming units 51Y to 51K all have the same configuration except for the toner used. Therefore, for the purpose of illustration and description, common constituent elements are denoted by the same reference numerals, and Y to K are added to the reference numerals when the constituent elements are to be distinguished from each other. In FIG. 1, reference signs are representatively provided to the constituent elements of the image forming unit 51Y for the Y component, and reference signs of the constituent elements of the other image forming units 51M to 51K are omitted.

Each of the image forming units 51 includes an exposure device (not illustrated), a developing device (not illustrated), a photosensitive drum 513, a charging device (not illustrated), a drum cleaning device (not illustrated), and the like.

The photosensitive drum 513 is, for example, a negatively charged organic photoreceptor in which an undercoat layer, a charge generation layer, and a charge transport layer are sequentially laminated on a peripheral surface of an aluminum conductive cylindrical body (aluminum pipe). The charge generation layer is made of an organic semiconductor in which a charge generation material (e.g., phthalocyanine pigment) is dispersed in a resin binder (e.g., polycarbonate). The charge generation layer generates a pair of positive and negative charges upon exposure by the exposure device. The charge transport layer is formed by dispersing a hole transport material (electron-donating nitrogen-containing compound) in a resin binder (e.g., polycarbonate resin). The charge transport layer transports positive charges generated in the charge generation layer to its surface.

The controller 10 rotates the photosensitive drum 513 at a constant circumferential speed by controlling a driving current supplied to a drive motor (not illustrated) that rotates the photosensitive drum 513.

The charging device uniformly charges a surface of the photosensitive drum 513 having photoconductivity to a negative polarity. The exposure device includes a semiconductor laser, for example, and irradiates the photosensitive drum 513 with laser light corresponding to an image of each color component. Positive charges are generated in the charge generation layer of the photosensitive drum 513 and are transported to the surface of the charge transport layer, whereby the surface charges (negative charges) of the photosensitive drum 513 are neutralized. On the surface of the photosensitive drum 513, an electrostatic latent image of each color component is formed due to a potential difference from the surroundings.

The developing device is, for example, a developing device of a two-component developing method. The developing device visualizes the electrostatic latent image by attaching the toner of each color component to the surface of the photosensitive drum 513, thereby forming a toner image.

The drum cleaning device includes a drum cleaning blade that comes in sliding contact with the surface of the photosensitive drum 513. The drum cleaning device removes untransferred toner remaining on the surface of the photosensitive drum 513 after the primary transfer.

### Intermediate Transfer Unit

The intermediate transfer unit 52 includes an intermediate transfer belt 521, a primary transfer roller (not illustrated), a plurality of support rollers (not illustrated), a secondary transfer roller 524, a belt cleaning device (not illustrated), and the like.

The intermediate transfer belt 521 is an endless belt that is stretched around the plurality of support rollers in a loop shape. At least one of the plurality of support rollers includes a drive roller, and the other includes a driven roller. For example, a roller disposed downstream of the primary transfer roller for the K component in a belt moving direction is preferably the drive roller. This allows the moving speed of the belt in a primary transfer section to be easily kept constant. As the drive roller rotates, the intermediate transfer belt 521 moves in the direction of arrow A at a constant speed.

The primary transfer roller is disposed on a side facing the inner peripheral side of the intermediate transfer belt 521, facing the photosensitive drums 513 of the respective color components.

The primary transfer roller is pressed against the photosensitive drums 513 with the intermediate transfer belt 521 interposed therebetween, thereby forming a primary transfer nip for transferring the toner images from the photosensitive drums 513 to the intermediate transfer belt 521.

The secondary transfer roller 524 is disposed on a side facing the outer peripheral side of the intermediate transfer belt 521, facing a backup roller (not illustrated) disposed downstream of the drive roller in the belt moving direction. The secondary transfer roller 524 is pressed against the backup roller with the intermediate transfer belt 521 interposed therebetween, thereby forming a secondary transfer nip for transferring the toner images from the intermediate transfer belt 521 to the recording medium P.

When the intermediate transfer belt 521 passes through the primary transfer nip, the toner images on the photosensitive drums 513 are sequentially superimposed and primary-transferred onto the intermediate transfer belt 521. Specifically, the toner images are electrostatically transferred to the intermediate transfer belt 521 by: applying a primary transfer bias to the primary transfer roller; and applying an electric charge having an opposite polarity of the toners to a back side of the intermediate transfer belt 521 (a side of the intermediate transfer belt 521 on which the primary transfer roller abuts).

Thereafter, when the recording medium P passes through the secondary transfer nip, the toner images on the intermediate transfer belt 521 are secondary-transferred to the recording medium P. Specifically, the toner images are electrostatically transferred to the recording medium P by: applying a secondary transfer bias to the secondary transfer roller 524; and applying an electric charge having an opposite polarity of the toners to the recording medium P on the side having the release paper P4 (the side of the recording medium P facing the secondary transfer roller 524). The recording medium P on which the toner images have been transferred is conveyed toward the fixing section 70.

The belt cleaning device includes a belt cleaning blade or the like that comes in sliding contact with a surface of the intermediate transfer belt 521, and removes untransferred toner remaining on the surface of the intermediate transfer belt 521 after the secondary transfer. Note that instead of the secondary transfer roller 524, a configuration in which a secondary transfer belt is stretched in a loop shape around a plurality of support rollers including a secondary transfer roller (a so-called belt-type secondary transfer unit) may be adopted.

### Recording Medium Conveyer

The recording medium conveyer 60 includes a sheet feed section 61, a sheet ejection section 62, a conveyance path section 63, and the like. The sheet feed section 61 includes a feeding roller 61a that feeds the recording medium P, which is continuous paper wound in a roll, downstream.

The recording medium P fed downstream of the sheet feed section 61 is conveyed to the image forming section 50 after passing through the preliminary heater 80 by the conveyance path section 63. In the image forming section 50, the toner images on the intermediate transfer belt 521 are collectively secondary-transferred to the surface base material P1 of the recording medium P, and fixing processing is performed in the fixing section 70. The sheet ejection section 62 includes a winding roller 62a that winds the recording medium P having the image formed thereon into a roll. The conveyance path section 63 includes conveyance rollers 63a that hold and convey the recording medium P. Note that the conveyance path section 63 may include a tension applying roller (not illustrated) that applies tension to the recording medium P and a meandering adjustment roller (not illustrated) that adjusts meandering of the recording medium P.

### Fixing Section

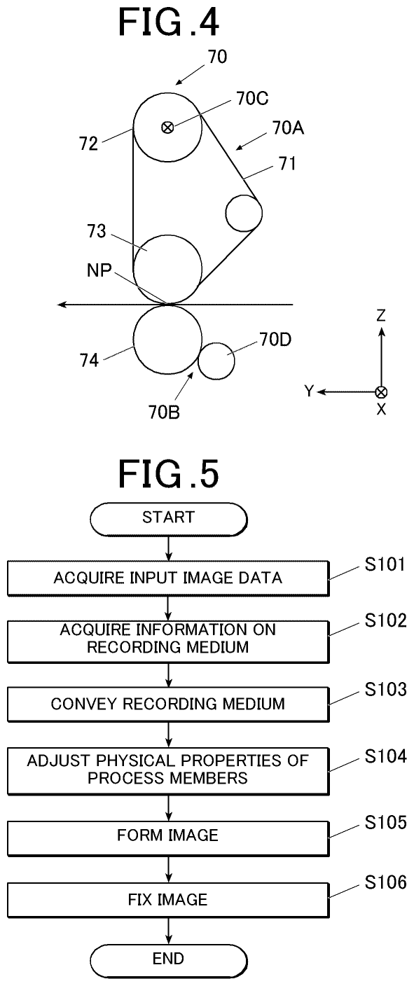

The fixing section 70 includes an upper fixing section 70A, a lower fixing section 70B, an upper heating source 70C, and a lower heating source 70D. FIG. 4 is a diagram schematically illustrating the fixing section 70. In the present embodiment, the fixing method is limited to a belt fixing method, but the present invention is not limited to the belt fixing method.

The fixing section 70 fixes the toner images to the recording medium P by heating and pressing the conveyed recording medium P, on which the toner images have been secondary-transferred, at a fixing nip. The fixing section 70 is disposed as a unit in a fixing device, that is, a housing.

### Upper Fixing Section

The upper fixing section 70A includes a fixing side member disposed on a side facing the surface base material P1 of the recording medium P. The upper fixing section 70A includes an endless fixing belt 71, a heating roller 72, and an upper pressure roller 73 (belt heating method), which constitute the fixing side member. The fixing belt 71 is stretched between the heating roller 72 and the upper pressure roller 73 with a predetermined tension. In the present embodiment, the upper fixing section 70A, together with the upper heating source 70C, faces the surface base material P1 and constitutes a first process member that acts on the surface base material P1 in the image forming process.

The fixing belt 71 is formed by covering an outer peripheral surface of a base body made of, for example, polyimide (PI) with heat-resistant silicon rubber as an elastic layer, and further covering or coating the surface layer with a tube made of perfluoroalkoxy (PFA), which is a heat-resistant resin. The fixing belt 71 comes into contact with the recording medium P on which the toner images have been formed, and heats and fixes the toner images to the recording medium P within a predetermined temperature range.

The heating roller 72 heats the fixing belt 71. The heating roller 72 incorporates an upper heating source 70C to heat the fixing belt 71. The upper heating source 70C is, for example, a halogen heater. The heating roller 72 is covered with a resin layer in which an outer peripheral surface of a cylindrical core metal formed of aluminum or the like is coated with polytetrafluoroethylene (PTFE).

The temperature of the upper heating source 70C is controlled by the controller 10. The heating roller 72 is heated by the upper heating source 70C, and as a result, the fixing belt 71 is heated. Thus, the toners formed on the recording medium P are heated. The controller 10 controls the upper heating source 70C based on, for example, an ON/OFF pattern of each half-wave with a predetermined duty ratio, to control the fixing temperature of the toners.

The upper pressure roller 73 is formed by covering a solid core made of metal, such as iron, with an elastic layer. As the material of the elastic layer, for example, heat-resistant silicone rubber may be used. The elastic layer may be formed by coating a heat-resistant silicone rubber with a resin layer coated with PTFE, which is a low-friction, heat-resistant resin. The upper pressure roller 73 is a fixing member that fixes a sheet to the recording medium P.

### Lower Fixing Section

The lower fixing section 70B includes a back side support member disposed on a side facing the release paper P4 of the recording medium P. In the present embodiment, the lower fixing section 70B, together with the lower heating source 70D, faces the release paper P4 and constitutes a second process member that acts on the release paper P4 in the image forming process.

The lower fixing section 70B includes a lower pressure roller 74 and a lower heating source 70D (roller pressure method), which constitute the back side supporting member. The lower pressure roller 74 is formed by coating an outer peripheral surface of a base material layer made of aluminum (Al) with an elastic layer. As the material of the elastic layer, for example, heat-resistant silicone rubber may be used. The elastic layer may be formed by coating a heat-resistant silicone rubber with a resin layer of a PFA tube as a surface release layer.

The lower heating source 70D incorporates a heating source such as a halogen heater. When the heating source generates heat, the lower pressure roller 74 is heated, and the toners formed on the recording medium P are heated. The controller 10 may control the heating source based on, for example, an ON/OFF pattern of each half-wave with a predetermined duty ratio, to control the fixing temperature of the toners.

The lower pressure roller 74 is pressed against the upper pressure roller 73 at a predetermined fixing load, with the fixing belt 71 interposed therebetween.

The lower pressure roller 74 makes the upper pressure roller 73 and the recording medium P be in pressure contact with each other in this manner. A fixing nip NP is formed between the upper pressure roller 73 and fixing belt 71 and the lower pressure roller 74 to nip and convey the recording medium P.

The lower pressure roller 74 is coupled to a motor, a gear, and the like (not illustrated), and a driving force of the motor is transmitted to the lower pressure roller 74. The controller 10 outputs a driving signal to the motor that drives the lower pressure roller 74 to control the circumferential speed of the lower pressure roller 74.

### Preliminary Heater

Returning to FIG. 1, the preliminary heater 80 is disposed upstream of the image forming section 50 in the conveyance direction and heats the recording medium P before image formation as necessary. The preliminary heater 80 includes a front side heater 81, a back side heater 82, a first temperature measurer 83, and a second temperature measurer 84.

### Front Side Heater, Back Side Heater

The front side heater 81 and the back side heater 82 are, for example, rollers in which a heating source such as a halogen heater is disposed inside a rotatable heat-conductive sleeve made of aluminum. The front side heater 81 and the back side heater 82 respectively heat the front side (surface base material P1) and the back side (release paper P4) of the recording medium P.

### First Temperature Measurer, Second Temperature Measurer

The first temperature measurer 83 is disposed upstream in the conveyance direction relative to the front side heater 81 and the back side heater 82. The first temperature measurer 83 measures, in a non-contact manner, the surface temperature of the recording medium P before heating by the front side heater 81 and the back side heater 82, and outputs the measurement result to the controller 10. The second temperature measurer 84 is disposed downstream in the conveyance direction relative to the front side heater 81 and the back side heater 82. The second temperature measurer 84 measures, in a non-contact manner, the surface temperature of the recording medium P after heating by the front side heater 81 and the back side heater 82, and outputs the measurement result to the controller 10.

### Image Forming Process

Next, the image forming process on the recording medium P by the image forming apparatus 1 according to the present embodiment will be described. FIG. 5 is a flowchart illustrating a schematic flow of the image forming process.

First, the controller 10 acquires input image data (step S101). As described above, the input image data can be acquired from a document by the image reading section 20, for example. Alternatively, the input image data can be acquired from an external device by the communicator 15, for example.

The controller 10 acquires information on the recording medium P (step S102). In the present embodiment, the controller 10 acquires the information on the recording medium P from the operation display part 30.

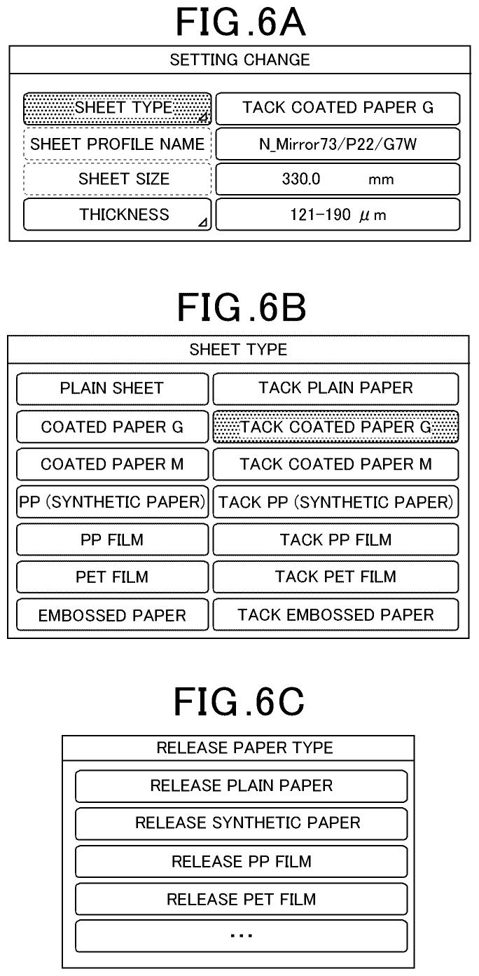

The controller 10 causes the display part 31 to display, for example, a setting change screen as illustrated in FIG. 6A, on which the type, thickness and the like of the recording medium P can be set and input. If the displayed information on the recording medium P is correct, the user approves the information by operating the operation part 32. On the other hand, for example, when the displayed information on the recording medium P is not correct, the user operates the operation part 32 to cause the display part 31 to display a recording medium type setting screen as illustrated in FIG. 6B, and specifies the type of the recording medium P including the type of the surface base material P1. In the recording medium type setting screen, when it is specified that the recording medium has a multilayer structure (is tack paper), the controller 10 causes the display part 31 to display a release paper type setting screen as illustrated in FIG. 6C. The user then specifies the type of release paper P4 of the recording medium P by operating the operation part 32. In this way, the controller 10 acquires information on the surface base material P1 and the release paper P4 of the recording medium P.

After the acquisition of the information on the recording medium P, the controller 10 causes the recording medium conveyer 60 to start conveying the recording medium P (step S103). In this step, the controller 10 acquires the surface temperature of the recording medium P from the first temperature measurer 83. Then, the controller 10 causes the front side heater 81 and/or the back side heater 82 to heat the recording medium P in accordance with the information on the recording medium P acquired in step S102 and the surface temperature. When heating is performed by the front side heater 81 and/or the back side heater 82, the controller 10 acquires the surface temperature of the recording medium P after heating from the second temperature measurer 84.

Then, the controller 10 adjusts a physical property of the process members based on the acquired information on the recording medium P including the surface temperature of the recording medium P (step S104). Specifically, in the present embodiment, the controller 10 adjusts the temperature of the upper pressure roller 73 (upper heating source 70C) based on the type of the surface base material P1. Further, the controller 10 adjusts the temperature of the lower pressure roller 74 (lower heating source 70D) based on the type of the release paper P4.

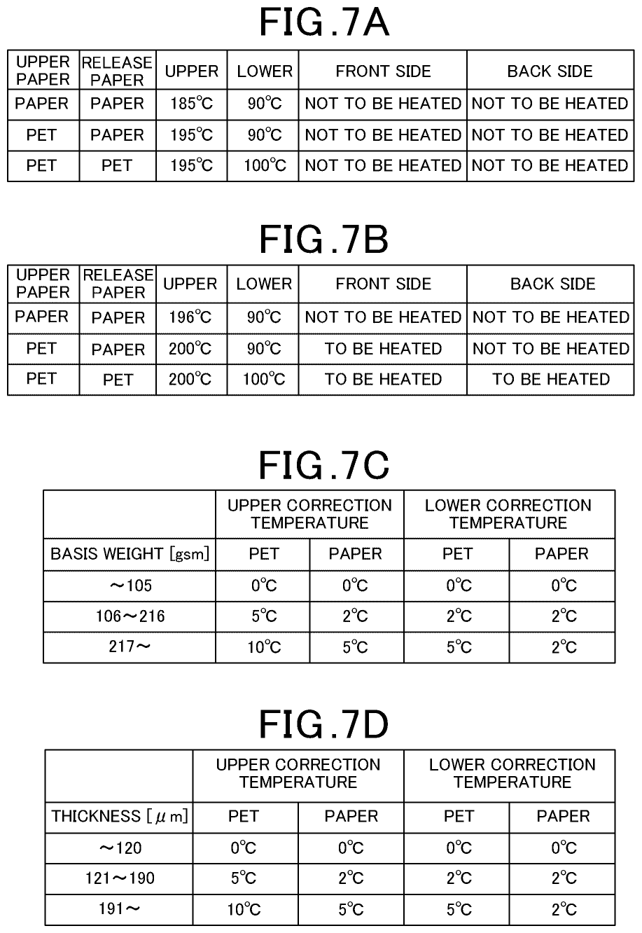

FIG. 7A and FIG. 7B illustrate temperature setting tables of the upper pressure roller 73 and the lower pressure roller 74 based on the types of the surface base material (upper paper) P1 and the release paper P4. Note that FIG. 7A illustrates a temperature setting table when the temperature of the recording medium P is 20° C. or higher, and FIG. 7B illustrates a temperature setting table when the temperature of the recording medium P is lower than 20° C.

As illustrated in FIG. 7A and FIG. 7B, the controller 10 controls the upper heating source 70C and/or the lower heating source 70D so that the temperature of the upper pressure roller 73 and/or the temperature of the lower pressure roller 74 are/is higher when the surface base material P1 and/or the release paper P4 are/is made of PET than when the surface base material P1 and/or the release paper P4 are/is made of paper, for example. This is because PET has a higher heat conductivity than paper, and even when PET is heated by the upper pressure roller 73 or the lower pressure roller 74, the heat is easily transmitted from the surface base material P1 to the release paper P4, lowering the fixing temperature, which is the surface temperature of the surface base material P1, and thereby reducing the image fixability.

Further, as illustrated in FIG. 7A and FIG. 7B, when the temperature of the recording medium P is lower than 20° C., the controller 10 controls the upper heating source 70C so that the temperature of the upper pressure roller 73 becomes higher than when the temperature of the recording medium P is 20° C. or higher. This is because when the temperature of the recording medium P is low, even if the recording medium P is heated with the upper pressure roller 73, the fixing temperature does not sufficiently rise, thereby reducing the image fixability.

As illustrated in FIG. 7C and FIG. 7D, the controller 10 corrects the temperatures of both process members based not only on the paper types of the surface base material P1 and the release paper P4 but also on the basis weights and the thicknesses of the surface base material P1 and the release paper P4. If the basis weight and thickness of the surface base material Pl or the release paper P4 are known, the heat capacity can be calculated from the specific heat and density based on the type of the surface base material P1 or the release paper P4. Therefore, the controller 10 controls the upper heating source 70C and/or the lower heating source 70D so that the temperature of the upper pressure roller 73 and/or the temperature of the lower pressure roller 74 become/becomes higher as the calculated heat capacity of the surface base material P1 and/or the calculated heat capacity of the release paper P4 are/is higher. Note that it is more preferable that the controller 10 controls the temperature of the process member in accordance with not only the heat capacity but also the heat conductivity of the surface base material P1 or the release paper P4, but it is not limited thereto.

However, when the surface temperature of the recording medium P is lower than 20° C., the surface base material P1 is made of PET, and the release paper P4 is made of paper, a sufficient fixing temperature cannot be achieved even if the temperatures of the upper pressure roller 73 and the lower pressure roller 74 are controlled. Therefore, as illustrated in FIG. 7B, in step S103, the controller 10 causes the front side heater 81 to heat the recording medium P to 20° C. or higher, thereby assisting the heating of the recording medium P by the upper pressure roller 73 and the lower pressure roller 74. Similarly, when the surface temperature of the recording medium P is lower than 20° C. and the surface base material P1 and the release paper P4 are made of PET, the controller 10 heats the recording medium P to a predetermined temperature by the front side heater 81 and the back side heater 82 in step S103.

After the adjustment of the process members, the controller 10 causes the image forming section 50 to form an image on the recording medium P (step S105).

After the image is formed, the controller 10 conveys the recording medium P to the fixing section 70 to fix the image (step S106) and ejects the recording medium P to the sheet ejection section 62. The image forming method and the image fixing method on the recording medium P by the image forming section 50 are the same as those in the related art, and thus detailed description thereof is omitted.

### Effects of First Embodiment

As described above, the image forming apparatus 1 according to the present embodiment includes the image forming section 50 that forms an image on the recording medium P having a multilayer structure, and the controller 10 that serves as an acquirer acquiring information on the recording medium P. The image forming apparatus 1 also includes the upper fixing section 70A that serves as the first process member physically acting on the recording medium P from the side facing the surface base material P1 of the recording medium P on which the image is formed. The image forming apparatus 1 further includes the lower fixing section 70B that serves as the second process member physically acting on the recording medium P from the side facing the release paper P4 opposite to the surface base material P1. Then, the controller 10 adjusts the temperature of at least the upper fixing section 70A based on the acquired properties of the surface base material P1. Further, the controller 10 adjusts the temperature of at least the lower fixing section 70B based on the properties of the release paper P4. According to the above-described configuration, a fixing process can be performed at an appropriate temperature according to the properties of the surface base material P1 and the release paper P4 of the multilayer structured recording medium P. This allows a more suitable process to be performed for providing the multilayer structured recording medium P on which an image is formed.

Furthermore, the controller 10 separately controls the physical quantities of the first process member and the second process member. Specifically, the controller 10 controls the temperatures of the upper pressure roller 73 and the lower pressure roller 74 separately. According to the above-described configuration, the fixing temperature can be more appropriately controlled when an image is formed on the multilayer structured recording medium P.

In addition, the controller 10 controls the temperature of the first process member and/or the temperature of the second process member to a higher temperature for the recording medium P having a higher heat conductivity and a higher heat capacity of the surface base material P1 and/or a higher heat conductivity and a higher heat capacity of the release paper P4. According to the above-described configuration, it is possible to prevent a situation in which the fixing temperature is lowered, failing to obtain sufficient image fixability.

In addition, the preliminary heater 80 that heats the recording medium P upstream of the upper pressure roller 73 and the lower pressure roller 74 in the conveyance direction is provided. Then, the controller 10 controls the temperature of the preliminary heater 80 so as to assist the heating of the recording medium P by the upper pressure roller 73 and the lower pressure roller 74. According to the above-described configuration, it is possible to prevent a situation in which the fixing temperature is lowered, failing to obtain sufficient image fixability.

### Second Embodiment

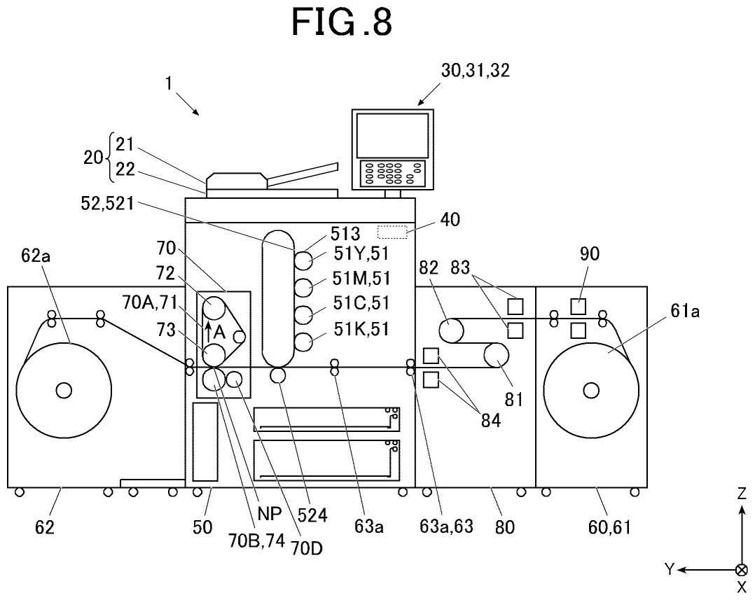

Next, an image forming apparatus 1 according to a second embodiment will be described with reference to FIG. 8. Note that contents that are the same as those of the first embodiment are denoted by the same reference signs, and a detailed description thereof will be omitted. As illustrated in FIG. 8, the image forming apparatus 1 according to the second embodiment is different from the first embodiment in that a detector 90 is provided. In addition, the second embodiment is different from the first embodiment in that the controller 10 acquires information on the recording medium P from a detection result of the detector 90 in step S102 of the image forming process.

### Detector

The detector 90 is disposed, for example, upstream relative to the preliminary heater 80 and the image forming section 50, and detects physical properties of the conveyed recording medium P. The detector 90 detects, for example, the density, air permeability, stiffness, electric resistance, thickness, smoothness, degree of smoothness, and the like of the recording medium P. Then, the detector 90 transmits the detected physical property values of the recording medium P to the controller 10. The controller 10 derives the basis weight, the paper type, and the like of the recording medium P based on the acquired physical properties, and adjusts the temperatures of the upper fixing section 70A and the lower fixing section 70B.

### Effects of Second Embodiment

As described above, the image forming apparatus 1 according to the present embodiment includes the detector 90 that detects information on properties of at least the surface base material P1 and the release paper P4 of the recording medium P. According to the above-described configuration, the information on the recording medium P can be acquired even if the user does not perform an operation input on the operation display part 30, and the same effects as in the first embodiment can be obtained without taking time and effort.

The detection by the detector 90 may be performed before the image forming process or during the image forming process.

### Modification Example

Although specific descriptions have been given above on the basis of the embodiments according to the present invention, the present invention is not limited to the above-described embodiments. It is a matter of course that the present invention can be subjected to various modifications within the scope of the invention described in the claims and the equivalents thereof.

For example, in the above description, the configuration in which the controller 10 controls the temperatures of the process members according to the temperature of the recording medium P has been exemplified, but the present invention is not limited thereto. The controller 10 may control the temperatures of the process members based on not only the temperature of the recording medium P but also the surrounding temperature. With this configuration, the fixing temperature can be more appropriately controlled. Further, the controller 10 may control the temperatures of the process members based on only the surrounding temperature.

In addition, in the above description, the case where the recording medium P is a roll of continuous paper has been exemplified, but the recording medium P is not limited thereto and may be sheets of paper. When the recording medium P is sheets of paper, the heat of the upper pressure roller 73 is transferred to the lower pressure roller 74 between the sheets. Therefore, the temperature of the upper pressure roller 73 may be set relatively low compared to when the recording medium P is a roll of continuous paper.

In the above description, the preliminary heater 80 has been exemplified as the configuration for heating the recording medium P to be equal to or higher than 20° C. when the temperature of the recording medium P is lower than 20° C. and the recording medium P has a predetermined paper type, but the present invention is not limited thereto. That is, it may be possible to adopt a configuration in which the front side heater 81 and the back side heater 82 are used as the first and second process members, respectively, and the temperature of the recording medium P is controlled based on information on the recording medium P and the surrounding temperature.

Further, in the above description, a configuration may be adopted in which a charge adjustment device disposed upstream of the image forming section 50 in the conveyance direction is used as a process member, and neutralization and charge may be adjusted as physical properties based on information on the recording medium P. Alternatively, a cooling device disposed downstream of the image forming section 50 in the conveyance direction may be used as a process member, and the cooling temperature may be adjusted as a physical property based on information on the recording medium P. Alternatively, a decurler disposed downstream of the image forming section 50 in the conveyance direction may be used as a process member, and the decurler condition may be adjusted as a physical property based on information on the recording medium P.

Note that in the configurations described above, the order of step S104 of adjusting the physical properties of the process members and step S105 of forming an image on the recording medium P may be interchanged.

In addition, in the above description, the front side heater 81 and the back side heater 82 have been exemplified as contact type heating members, which heat the recording medium P by directly contacting the recording medium P, but the present invention is not limited thereto. The front side heater 81 and the back side heater 82 may be non-contact heating members such as hot air devices.

Although a hard disk, a semiconductor nonvolatile memory, or the like is used as the computer-readable recording medium according to the embodiments of the present invention, the present invention is not limited thereto. As another computer-readable recording medium, a portable recording medium such as a CD-ROM can be applied. Further, as a medium for providing data of the program stored in the recording medium according to the embodiments of the present invention via a communication line, a carrier wave is also applied. Although embodiments of the present invention have been described and shown in detail, the disclosed embodiments are made for purposes of illustration and example only and not limitation. The scope of the present invention should be interpreted by terms of the appended claims.

The entire disclosure of Japanese Patent Application No. 2023-215478 filed on Dec. 21, 2023, is incorporated herein by reference in its entirety.

What is claimed is:

1. An image forming apparatus, comprising:
an image forming section that forms an image on a recording medium having a multilayer structure;
a hardware processor that acquires information on the recording medium;
a first process member that physically acts on the recording medium from a first side on which the image is to be formed; and
a second process member that physically acts on the recording medium from a second side opposite to the first side, wherein
the hardware processor
adjusts a physical property of at least the first process member, the physical property acting on the recording medium, based on a first property of an uppermost layer on the first side of the recording medium, the first property being acquired by the hardware processor, and
adjusts a physical property of at least the second process member, the physical property acting on the recording medium, based on a second property of an uppermost layer on the second side of the recording medium.

2. The image forming apparatus according to claim 1, wherein
the first process member faces the uppermost layer on the first side of the recording medium,
the second process member faces the uppermost layer on the second side of the recording medium, and
the hardware processor separately controls a physical quantity of the first process member and a physical quantity of the second process member.

3. The image forming apparatus according to claim 2, wherein
the first process member includes a fixing member that fixes the image onto the recording medium,
the second process member includes a pressure member that makes the fixing member and the recording medium be in pressure contact with each other, and
the hardware processor separately controls a temperature of the fixing member and a temperature of the pressure member.

4. The image forming apparatus according to claim 3, wherein
the first property and the second property are heat conductivity, and
the hardware processor controls the temperature of the fixing member and/or the temperature of the pressure member to a higher temperature for the recording medium having a higher heat conductivity of the uppermost layer on the first side and/or a higher heat conductivity of the uppermost layer on the second side.

5. The image forming apparatus according to claim 3, wherein
the first property and the second property are heat capacity, and
the hardware processor controls the temperature of the fixing member and/or the temperature of the pressure member to a higher temperature for the recording medium having a higher heat capacity of the uppermost layer on the first side and/or a higher heat capacity of the uppermost layer on the second side.

6. The image forming apparatus according to claim 3, wherein the hardware processor controls a condition of the fixing member and a condition of the pressure member in accordance with a surrounding temperature and/or a temperature of the recording medium.

7. The image forming apparatus according to claim 2, further comprising:
a fixing member that fixes the image onto the recording medium; and
a pressure member that makes the fixing member and the recording medium be in pressure contact with each other, wherein
the first process member and the second process member are preliminary heaters that heat the recording medium upstream of the fixing member and the pressure member in a conveyance direction.

8. The image forming apparatus according to claim 3, further comprising a preliminary heater that heats the recording medium upstream of the fixing member and the pressure member in a conveyance direction, wherein the hardware processor controls the preliminary heater to assist heating of the recording medium by the fixing member and the pressure member.

9. The image forming apparatus according to claim 7, wherein the hardware processor controls a temperature of the preliminary heater in accordance with a surrounding temperature and/or a temperature of the recording medium.

10. The image forming apparatus according to claim 1, wherein the recording medium is continuous paper.

11. The image forming apparatus according to claim 1, further comprising an operation part that receives, by an input operation, information on at least the first property of the uppermost layer on the first side of the recording medium and the second property of the uppermost layer on the second side of the recording medium, wherein the hardware processor acquires the information received by the operation part.

12. The image forming apparatus according to claim 1, further comprising a detector that detects information on at least the first property of the uppermost layer on the first side of the recording medium and the second property of the uppermost layer on the second side of the recording medium, wherein the hardware processor acquires the information detected by the detector.

13. An image forming method of an image forming apparatus, wherein
the image forming apparatus includes:
an image forming section that forms an image on a recording medium having a multilayer structure;
a hardware processor that acquires information on the recording medium;
a first process member that physically acts on the recording medium from a first side on which the image is to be formed; and
a second process member that physically acts on the recording medium from a second side opposite to the first side, and
the image forming method comprises:
adjusting a physical property of at least the first process member, the physical property acting on the recording medium, based on a first property of an uppermost layer on the first side of the recording medium, the first property being acquired by the hardware processor; and
adjusting a physical property of at least the second process member, the physical property acting on the recording medium, based on a second property of an uppermost layer on the second side of the recording medium.

14. A non-transitory recording medium storing a computer-readable program for an image forming apparatus, wherein
the image forming apparatus includes:
an image forming section that forms an image on a recording medium having a multilayer structure;
a hardware processor that acquires information on the recording medium;
a first process member that physically acts on the recording medium from a first side on which the image is to be formed; and
a second process member that physically acts on the recording medium from a second side opposite to the first side, and
the program causes the hardware processor to:
adjust a physical property of at least the first process member, the physical property acting on the recording medium, based on a first property of an uppermost layer on the first side of the recording medium, the first property being acquired by the hardware processor; and
adjust a physical property of at least the second process member, the physical property acting on the recording medium, based on a second property of an uppermost layer on the second side of the recording medium.
